(19) United States
(12) Patent Application Publication
(10) Pub. No.: US 2008/0257969 A1
(43) Pub. Date: Oct. 23, 2008

(54) THERMOSTATIC VALVE

(76) Inventor: Oscar NEMBER, Rodengo Saiano (Brescia) (IT)

Correspondence Address: MCGLEW & TUTTLE, PC, P.O. BOX 9227, SCARBOROUGH STATION, SCARBOROUGH, NY, 10510-9227, US

(21) Appl. No.: 12/105,467

(22) Filed: Apr. 18, 2008

(30) Foreign Application Priority Data
Apr. 20, 2007 (IT) BS 2007 U 000020
Jan. 31, 2008 (IT) BS 2008 U 000005

(51) Int. Cl. G05D 23/02

(52) U.S. Cl. 236/93 A

(57) ABSTRACT

The invention concerns a thermostatic valve to control the delivery of hot, cold and mixed water, that comprises a thermostatic bulb (17) in connection with a mixer control device (19), which solicited by a spring (21) that rests against it by means of a cap (28) for a uniform action of the spring on all the contact surface of the cap with said device. Furthermore the control device (19) has some radial holes (194) to convey the water towards the thermostatic bulb in a more satisfactory way.

This invention concerns the field of the valves and in particular to thermostatic valves, also known as thermostatic cartridges, to control the flow of hot, cold and selectively mixed water.

A thermostatic valve usually comprises coaxially inside a cartridge body a thermostatic bulb and a control device of the mixing, also known as a basket. The latter is susceptible to axial movements in response to the dilatations the thermostatic bulb is subject to due to the variations in temperature of the water supplied. The cartridge body has lateral input conduits at different levels for the feeding of hot and cold water towards a mixing chamber, that contains the thermostatic bulb with the mixing device and which is in communication with an output passage of the water towards the user service. The movements of the nixing control device, or basket, are opposed by two different springs, associated respectively with the mixing control device and the cover resting on the top of the thermostatic bulb.

This known embodiment is suitable in the setting and control of supply of temperate mixed water, usually up to as high as 38° C., but not completely reliable in other circumstances. According to some market regulations in some countries, the supply of hot water must stop automatically should the cold water supply be lacking and as soon as a precise temperature is reached, e.g. 46° C., so as to avoid damages and risk of people getting scalded. In this case the mixing control device, if due to the operating tolerances and coupling play does not flow perfectly in the cartridge body, even if stressed by the thermostatic bulb, the risk is run of the hot water input passage jamming or not closing immediately and completely. A further cause of this malfunction may also be found in a different and irregular action of the contrast spring that rests freely against the mixing control device.

An objective of this invention is to efficiently remedy this drawback and to therefore create the conditions for safe and reliable operation of the of the thermostatic valve in every one of its usage conditions, and in particular when the cold water is lacking and a fast closing operation of the supply of hot water is required.

Then, because of its configuration, the mixing control device or basket, can also be an obstacle to the supply of water, in particular the hot water in the mixing chamber where the thermostatic bulb is positioned. In this case the thermostatic bulb is not correctly struck by the flow of water so that the efficient and fast control of the temperature of the mixed water can become a problem.

A further objective of the invention is to actually remedy also this problem of the thermostatic valve so as to enable the water to strike the thermostatic bulb correctly using the mixing control device, or basket, and to allow an immediate and more precise control of the temperature of the mixed water.

These objectives are reached with a thermostatic mixing valve according to at least the characterizing part of claim 1 and therefore, advantageously, by a uniform action of the spring on all of a front surface of the mixing control device.

This invention will however be illustrated in greater detail in the following description made with reference to the enclosed drawings, in which:

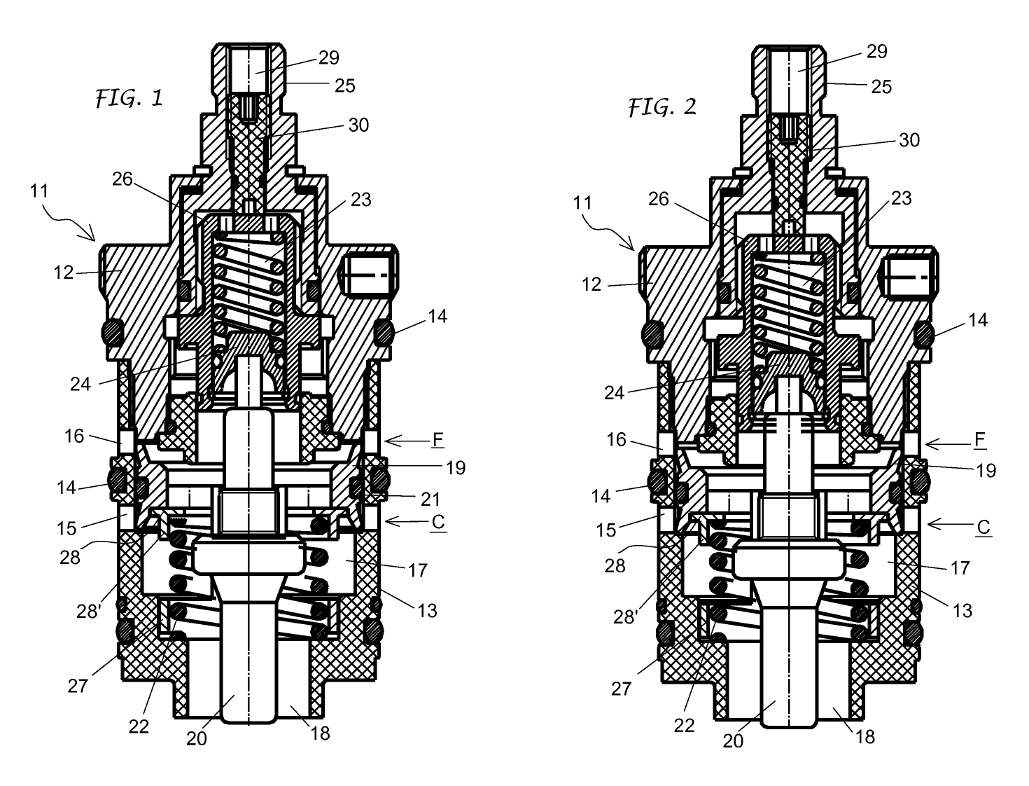

FIG. 1 shows an enlarged axial cross section of a thermostatic valve a normal operating condition;

FIG. 2 shows a similar section of the thermostatic valve, but in the completely closed position of the input passage of the hot water;

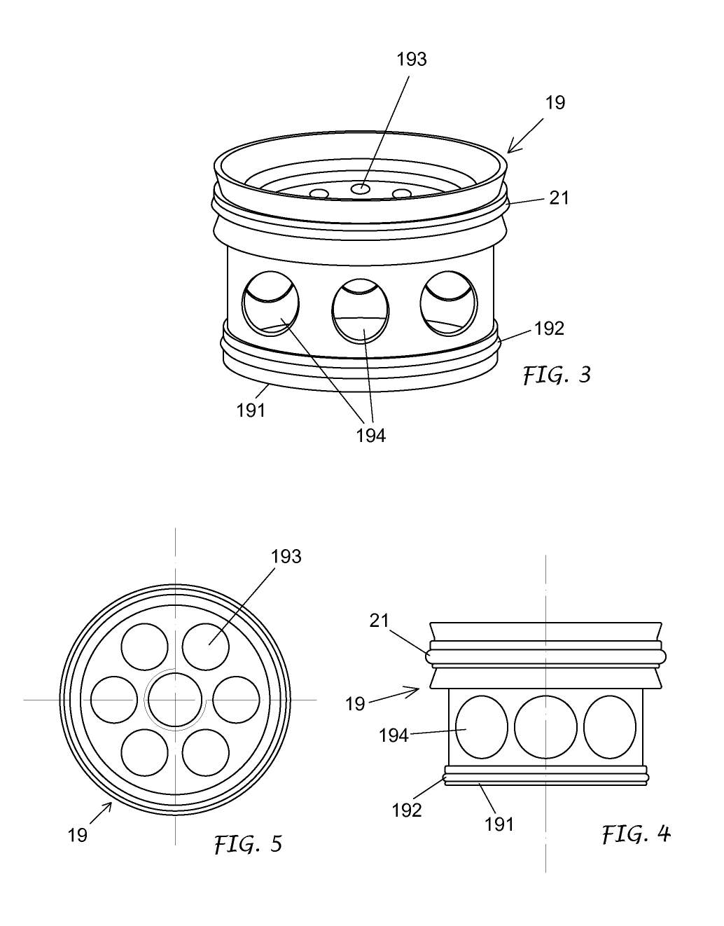

FIG. 3 shows an enlarged view in perspective of the mixing control device;

FIGS. 4 and 5 show the side and top views of the control device in FIG. 3; and

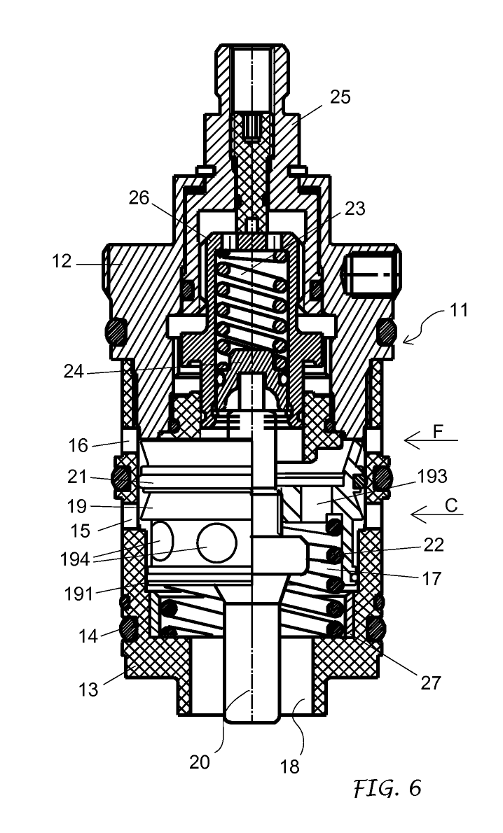

FIG. 6 shows an enlarged axial section of a thermostatic valve housing said control organ.

As shown, the thermostatic valve comprises a cartridge body 11 that can be made up of a glass shaped element 12 associated with an external jacket 13. Some seals 14 are positioned around the cartridge body 11. Radially, in the external jacket 13 are provided, on a first level, some first hot water H input holes or conduits 15 and on a different level, some second input holes or conduits 16 of the cold water C. Both the former and the latter empty into a mixing chamber 17 provided with an output opening 18 at the bottom for the water, which directly or indirectly connects up to a user source by means of a conduit connected to it. A device 19 is assembled axially in the mixing chamber 17, provided to control the mixing of the water, and said device 19 is associated with and connected to a thermostatic bulb 20.

The mixing control device 19 is guided in the cartridge body by the interposition of at least one seal 21 which positions itself between, and separates, the input holes or conduits 15 for the hot water and the holes or slots 16 of the cold water. More precisely, the mixing control device 19 is positioned in the mixing chamber 17 on a level with the radial holes or conduits 15, 16 respectively of the hot and cold water, and is guided in the body 11 and susceptible to axial movements caused by the thermostatic bulb 20. This bulb is in contact with and is influenced by the temperature of the water flowing in the mixing chamber and, expanding according to the temperature of the water, causes the movements of the mixing device that closes/opens the hot and cold water holes or slots 15, 16 differently and in this way varies the ratio of the two types of mixed water so as to maintain the temperature of the water supply constant.

The movements of the mixing organ are however contrasted by two different opposing springs 22, 23 associated, respectively, with the device and a cover 24 resting on the top of the thermostatic bulb 20.

The temperature of the mixed water can be set by the use of a handle-not shown-fixed to a turnable shaft 25 associated with the thermostatic bulb 20 by means of a slider 26 that engages with the spring 23 and, by means of this, the cover 24 that rests on top of the bulb.

According to a characteristic aspect of the invention, the spring 22 associated with the mixing control device 19, has one of its ends that rests on a striking surface inside the jacket 13 and which is possibly surrounded by a sleeve 27, and its opposite end that rests on said device 19, not directly but by means of a cap 28 that can also have a centring collar 28′ of the spring. Thanks to the cap the force of the spring 22 is uniformly divided on the device 19 so that the latter slides in the body parallel to itself, without unbalancing which may reduce the movement sensibility, in response to the dilatations of the thermostatic bulb resulting in avoiding every possibility of the valve failing.

According to another aspect of the invention, the device 19 has an annular extension 191 facing towards the bottom opening 18, centred and guided along the internal surface of the mixing chamber with the interposition of a seal 192. Furthermore it has a transversal baffle with through holes 193 (FIGS. 3 and 5), in a basically parallel direction to the thermostatic bulb 20, so as to place the part of the mixing chamber above the mixing device 19 at the level of which are the cold water holes or slots 16, in communication with the part of the mixing chamber below the mixing device 19 at the level of which are the hot water holes or slots 15. In the annular extension of the mixing device there are some radial holes provided 194 with a certain span, such to place the holes and slots 15 of the hot water supply in communication with the mixing chamber. These radial holes 194 of the mixing device 19 have the task of adjusting the input flow of the hot water and to hold and direct this water to a certain extent so that it can mix more uniformly with the cold water on a level with the thermostatic bulb for an effective and more precise control of the temperature of the mixed water to be supplied.

Finally, worthy of note is that the turning shaft 25 is provided axially with a threaded hole 29 in which an adjusting dowel 30 that rests on the top of the slider and by screwing/unscrewing of which (FIGS. 1 and 2) it is possible to vary the axial position of the thermostatic bulb 20 and, by means of the latter, the position of the mixing device 19 to set the maximum temperature at which the supply of hot water must be stopped.

1. Thermostatic valve for the control of the delivery of mixed water, comprising a cartridge body and, coaxially inside said body, a thermostatic bulb (20) and a mixing control device (19) associated and connected together, and where
the cartridge body has, at different levels, some radial holes or conduits (15, 16) for an input of respectively hot and cold water to a mixing chamber (17) with an output opening of mixed water towards a user point;
the thermostatic bulb (20) and the mixer control device (19) are positioned in said mixer chamber, together with said control device operating on a level with said hot and cold input holes or conduits;
said mixer control device is susceptible to axial movements in response to dilatations the thermostatic bulb is subject to as the temperature of the water changes; and
the movements of the mixer control device are opposed by two different opposite springs (22, 23) respectively associated with the device itself and with a cover resting on the summit of the thermostatic bulb;
wherein between the mixer control device (19) and the spring (22) associated with it there is a cap (28) for a uniform distribution of the thrust of said spring (22) on all the contact surface of said cap with said control device.

2. Thermostatic valve according to claim 1, wherein said mixer control device (19) has an annular extension (191) facing towards the water output passage and having some radial holes (194) on a level and in communication with the hot water input holes or slots (15) for a better control of the mixing and temperature of the mixed water supply.

3. Thermostatic valve according to claim 1, wherein the spring (22) associated with the mixer control device (19) has an end that rests on a striking surface inside the cartridge body and possibly surrounded by a sleeve (27), and an opposite end that rests on said cap (28).

4. Thermostatic valve according to claim 3, wherein said cap (28) has a centring collar (28′) of the proximate end of said spring (22).

5. Thermostatic valve according to claim 2, wherein the annular extension (191) of the mixing control device (19) is guided along the internal surface of the mixing chamber (17) with the interposition of a seal (192), and said radial holes (194) are positioned between said control device and said seal (192).

6. Thermostatic valve according to claim 5, wherein the mixing control device (19) has a transversal baffle constrained to the thermostatic bulb and has some holes (193), on a level with which are the holes or slots (16) of the input of the cold water, so as to place a part of the mixing chamber above in communication with a part of the mixing chamber below, on a level with which are the holes or slots (15) of the input for the hot water.

7. Thermostatic valve according to claim 1, wherein the spring (22) associated with the control device (19) extends inside said annular extension (191).

8. Thermostatic valve according to claim 1, wherein a dowel (30) is screwed axially in a turning shaft controlling the position of the thermostatic bulb by means of an associated slider, said dowel resting on said slider to set the position of the mixer control device (19) and with the latter to vary the maximum temperature at which the supply of hot water is interrupted.

9. Thermostatic valve according to claim 2, wherein the spring (22) associated with the mixer control device (19) has an end that rests on a striking surface inside the cartridge body and possibly surrounded by a sleeve (27), and an opposite end that rests on said cap (28).

10. Thermostatic valve according to claim 2, wherein the spring (22) associated with the control device (19) extends inside said annular extension (191).

11. Thermostatic valve according to claim 3, wherein the spring (22) associated with the control device (19) extends inside said annular extension (191).

12. Thermostatic valve according to claim 4, wherein the spring (22) associated with the control device (19) extends inside said annular extension (191).

13. Thermostatic valve according to claim 5, wherein the spring (22) associated with the control device (19) extends inside said annular extension (191).

14. Thermostatic valve according to claim 6, wherein the spring (22) associated with the control device (19) extends inside said annular extension (191).

15. Thermostatic valve according to claim 2, wherein a dowel (30) is screwed axially in a turning shaft controlling the position of the thermostatic bulb by means of an associated slider, said dowel resting on said slider to set the position of the mixer control device (19) and with the latter to vary the maximum temperature at which the supply of hot water is interrupted.

16. Thermostatic valve according to claim 3, wherein a dowel (30) is screwed axially in a turning shaft controlling the position of the thermostatic bulb by means of an associated slider, said dowel resting on said slider to set the position of the mixer control device (19) and with the latter to vary the maximum temperature at which the supply of hot water is interrupted.

17. Thermostatic valve according to claim 4, wherein a dowel (30) is screwed axially in a turning shaft controlling the position of the thermostatic bulb by means of an associated slider, said dowel resting on said slider to set the position of the mixer control device (19) and with the latter to vary the maximum temperature at which the supply of hot water is interrupted.

18. Thermostatic valve according to claim 5, wherein a dowel (30) is screwed axially in a turning shaft controlling the position of the thermostatic bulb by means of an associated slider, said dowel resting on said slider to set the position of the mixer control device (19) and with the latter to vary the maximum temperature at which the supply of hot water is interrupted.

19. Thermostatic valve according to claim 6, wherein a dowel (30) is screwed axially in a turning shaft controlling the position of the thermostatic bulb by means of an associated slider, said dowel resting on said slider to set the position of the mixer control device (19) and with the latter to vary the maximum temperature at which the supply of hot water is interrupted.

20. Thermostatic valve according to claim 7, wherein a dowel (30) is screwed axially in a turning shaft controlling the position of the thermostatic bulb by means of an associated slider, said dowel resting on said slider to set the position of the mixer control device (19) and with the latter to vary the maximum temperature at which the supply of hot water is interrupted.
